(19) United States
(12) Patent Application Publication
(10) Pub. No.: US 2004/0255102 A1
(43) Pub. Date: Dec. 16, 2004

(54) Data processing apparatus and method for transferring data values between a register file and a memory

(76) Inventor: Wilco Dijkstra, Cambridge (GB)

Correspondence Address: NIXON & VANDERHYE, PC, 1100 N GLEBE ROAD, 8TH FLOOR, ARLINGTON, VA, 22201-4714, US

(21) Appl. No.: 10/812,034

(22) Filed: Mar. 30, 2004

(30) Foreign Application Priority Data
Jun. 12, 2003 (GB) 0313642.1

(51) Int. Cl. G06F 9/30

(52) U.S. Cl. 712/225

(57) ABSTRACT

A data processing apparatus and method are provided for transferring data values between a register file and a memory. The data processing apparatus comprises a data processing unit operable to perform data processing operations on data values, and a register file having a plurality of registers operable to store the data values for access by the data processing unit. The data processing unit is responsive to a single transfer instruction to perform multiple data value transfers between a corresponding multiple of the registers of the register file and consecutive data value addresses in a memory. The single transfer instruction provides an address identifier from which the consecutive data value addresses are derivable, and further provides for each of the data value transfers a register identifier identifying the register within the plurality of registers which is the subject of that data value transfer. Furthermore, the register identifier for each of the data value transfers is specifiable independently of the register identifiers specified for the other of the data value transfers, thus providing significantly enhanced flexibility of use of this single transfer instruction.

### BACKGROUND OF THE INVENTION

1. Field of the Invention

The present invention relates to a data processing apparatus and method for transferring data values between a register file and a memory.

2. Description of the Prior Art

A data processing apparatus will typically have a data processing unit which is operable to perform data processing operations on data values. The data processing unit will have access to a register file having a plurality of registers which are operable to store the data values required by the data processing unit during the performance of those data processing operations. The instructions to be executed by the data processing unit in order to perform those data processing operations will then typically specify registers within the register file containing data values to be used as operands for those data processing operations.

The register file provides the data processing unit with quick access to the data values, but is relatively small and so cannot hold all of the data values that may be required by the data processing unit. Hence, a memory system is typically provided for longer term storage of the data values, with data values being transferred between the register file and the memory system as and when required. By this approach, it is possible to store data values from the register file to the memory when they are no longer required by the data processing unit, and also for data values to be loaded from the memory into the register file when needed so that they are then available to the data processing unit. A typical load instruction used to load a data value into the register file may be represented as follows:

LDR R_{X}, [R_{Z}, # OFFSET]

The register R_{Z} is arranged to contain a base address to which is added the offset value in order to produce the memory address containing the required data value. When the load instruction is executed, the data value at that address is retrieved from memory and written into the register R_{X} of the register file.

A typical store instruction may be represented as follows:

STR R_{X}, [R_{Z}, # OFFSET]

As before, the relevant memory address is given by adding the offset value to the data value stored within the register R_{Z}, but in this instance the data value stored within the register R_{X} is then written to that memory address within the memory.

It will be appreciated that within a typical program to be executed on the data processing apparatus, there will be a significant number of such load and store instructions, and indeed it is common for a plurality of such load or store instructions to appear one after the other in a sequence of code in order to access adjacent memory locations, for example when accessing 64-bit “long long” or “double” data types using 32-bit loads or stores, or when accessing adjacent structure fields. Hence, as an example, the following sequence of two load instructions may occur:

LDR R_{X}, [R_{Z}, # OFFSET]

LDR R_{Y}, [R_{Z}, # OFFSET±INCR]

In both load instructions, the same base address is used, but for the second load instruction the offset is incremented or decremented by a number of bytes equal to the number of bytes in each data value. Hence, as an example, if the data values are 32-bit data values, i.e. 4-bytes in length, then the offset for the first load instruction may be 0, and the offset for the second load instruction will in that event be ±4.

In an endeavour to increase processing speed, recent architectures for a data processing apparatus have provided multiple read and/or multiple write ports for the register file in order to allow more than one register to be accessed in each clock cycle. In order to take advantage of this, new instructions have been developed which in certain situations allow two or more sequential load or store instructions to be replaced by a single instruction. One example is a load multiple instruction available in microprocessors designed by ARM Limited, which can be represented as follows:

LDMIA R_{Z}, {R_{X}, R_{Y}}

Constraints: 1) R_{Y}>R_{X}

2) Base offset starts from 0

The above example assumes that one is attempting to replace the earlier identified two load instructions with a single load multiple instruction. This instruction will cause the register R_{X} to be written with the data value at the memory location identified by the contents of register R_{Z}, and the register R_{Y} to then be written with the data value stored at the memory location identified by the contents of the register R_{Z} plus an increment value equal to the data value size. Hence two data values from consecutive memory addresses will be stored into the registers R_{X} and R_{Y}.

The LDMIA instruction is not limited to performing two load operations as described above. The destination registers for the load operations are specified by a bit mask, and hence as an example if the register file contains 16 registers, the bit mask may be provided as a 16-bit field of the instruction with each bit of the bit mask being associated with a corresponding register. Assuming the register R_{X} is register 0 and the register R_{Y} is register 2, the bit mask for the above example of the LDMIA instruction may be as follows:

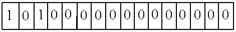

In this example, it is assumed that the value “1” identifies a register to which a data value should be loaded, and a value of “0” denotes a register to which a data value should not be loaded.

Whilst this LDMIA instruction allows potentially a large number of registers to be loaded as a result of a single instruction, there are a number of constraints which limit its use. Firstly, the bit mask imposes an ordering on the registers used. The data value at the first address will be loaded into the first register identified by the bit mask as a destination register, the data value from the next consecutive address will be loaded into the next register identified by the bit mask as a destination register, etc. Hence, this single instruction can only be used to combine memory accesses that specify both increasing addresses and increasing destination registers. Hence, considering the earlier example of two LDR instructions, if register R_{X} is register 0 and register R_{Y} is register 2, then this instruction may potentially be used if the offset is increasing. However, if the register R_{X} is register 2, and the register R_{Y} is register 0, then this instruction cannot be used.

In addition, since the bit mask takes up a significant amount of the bit space available to specify the instruction, there is not sufficient space available within the instruction to specify an offset, and accordingly this further limits the number of cases where the LDMIA instruction can be used. Hence, considering the earlier mentioned sequence of two LDR instructions, if the offset for the first LDR instruction is zero, then it may be possible to use the LDMIA instruction, but if the first offset is non-zero, then the LDMIA instruction cannot typically be used.

In addition to the LDMIA instruction, a corresponding STMIA instruction may also be provided for storing multiple data values from the register file to memory. However, exactly the same constraints apply. To alleviate some of the constraints associated with the LDMIA and STMIA instructions, load and store register pair instructions have been developed for use in microprocessors designed by ARM Limited. The register pair load instruction can be represented as follows:

LDRD R_{X}, [R_{Z}, # OFFSET]

Constraints: 1) Can only load R_{X} and R_{X+1}, i.e. Y=X+1 (and R_{X} even)

2) base+offset must be 8 byte aligned.

This instruction enables two registers to be loaded with data values, and has an offset field like the earlier described single register load (LDR) instructions. This instruction loads into register R_{X} the data value located in memory at the address given by adding the offset to the contents of the register R_{Z}. It then also loads into the register R_{X+1} the data value at the adjacent, i.e. consecutive, data value address. Furthermore, because this instruction was designed for use in systems where the register file is considered to consist of pairs of registers in which can be stored two separate single data words, or one double data word, it can only be used in situations where the register R_{X} is an even register, e.g. register 0, register 2, register 4, etc and the address value given by adding the base address to the offset must be aligned on an 8-byte boundary in memory.

Whilst this LDRD instruction can provide good performance in hardware assuming the hardware has been arranged appropriately, it is difficult for software to be written so that it can always take advantage of such an instruction, due to the above mentioned constraints.

A similar register pair store instruction, referred to as an STRD instruction, can also be provided, but this again is subject to exactly the same constraints as the LDRD instruction.

From the above discussion, it can be seen that both of the above described techniques for allowing multiple loads or stores to be specified by a single instruction place significant constraints on the registers that can be identified for each transfer. In particular, the choice of the register for the first transfer will limit the choices available for the subsequent transfer. As an example, considering the LDMIA instruction, if the first register identified within the bit mask is register R4, then the next transfer cannot be made to any of the registers R0 to R4, but instead must be made to a register having a higher register number. Further, considering the LDRD instruction, whichever register is specified for the first transfer, the register that is used for the next transfer is the adjacent register in the even/odd register pair.

Accordingly, it is an object of the present invention to provide a technique which allows a data processing apparatus to be responsive to a single transfer instruction to perform multiple transfers between a register file and memory, whilst alleviating some of the constraints associated with the known techniques.

### SUMMARY OF THE INVENTION

Viewed from a first aspect, the present invention provides a data processing apparatus, comprising: a data processing unit operable to perform data processing operations on data values; a register file having a plurality of registers operable to store said data values for access by the data processing unit; the data processing unit being responsive to a single transfer instruction to perform multiple data value transfers between a corresponding multiple of said registers of said register file and consecutive data value addresses in a memory, the single transfer instruction providing an address identifier from which said consecutive data value addresses are derivable, and further providing for each of said data value transfers a register identifier identifying the register within said plurality of registers which is the subject of that data value transfer, said register identifier for each of said data value transfers being specifiable independently of the register identifiers specified for the other of said data value transfers.

In accordance with the present invention a single transfer instruction is defined which when executed on the data processing unit will cause multiple data value transfers to be performed between a corresponding multiple of registers of the register file and consecutive data value addresses in memory. The single transfer instruction provides an address identifier from which the consecutive data value addresses are derivable. Typically, the address identifier will provide information from which one of the data value addresses can be derived, for example the data value address associated with the first transfer, and any of the consecutive data value addresses can then be derived from that data value address by incrementing or decrementing that address by the data value size, or multiples thereof The single transfer instruction further provides for each of the data value transfers a register identifier identifying the register within the plurality of registers which is the subject of the data value transfer. Furthermore, the register identifier for each of the data value transfers is specifiable independently of the register identifiers specified for the other of the data value transfers. This provides a great deal of flexibility in use of the single transfer instruction, and hence allows significantly more occurrences of multiple separate instructions, each used to transfer one data value, to be replaced by this new single transfer instruction.

In particular, it can be seen when comparing this new single transfer instruction with the earlier described LDMIA instruction, that there is now no limitation that the register numbers must increase for each subsequent transfer performed. Further, when compared with the earlier described LDRD instruction, there is no requirement for the transfers to take place with respect to two adjacent registers, nor for the first register to be an even-numbered register. As a result, it is clear that there is significantly more scope for replacing a series of instructions that each transfer a single data value with one or more occurrences of this new single transfer instruction.

It will be appreciated that the transfers may take place either from the registers to the memory, or from the memory to the registers. Accordingly, in one embodiment the single transfer instruction is a load instruction, the data processing unit being responsive to the load instruction to perform said multiple data value transfers from the consecutive data value addresses in said memory to said corresponding multiple of said registers of said register file. By this approach, the loading of multiple data values into the registers from memory can be invoked by a single load instruction, thus yielding improvements in code size, and also allowing improved performance in hardware assuming the hardware allows a number of data values to be loaded into the registers in parallel.

In one embodiment, to allow transfers to take place from the registers to memory, the single transfer instruction is a store instruction, the data processing unit being responsive to the store instruction to perform said multiple data value transfers from said corresponding multiple of said registers of said register file to the consecutive data value addresses in said memory. Hence, this allows the transfer of multiple data values from the registers to memory to be specified by a single store instruction, and thus again allows a decrease in code size whilst also facilitating an increase in hardware performance assuming the hardware allows the register file to output more than one data value to memory in parallel.

It will be appreciated that the address identifier can take a variety of forms. However, in one embodiment, the address identifier comprises a base address and an offset value. By allowing the provision of an offset value, it will be appreciated that this single transfer instruction provides significantly more flexibility than the earlier described LDMIA instruction, which due to the amount of available space within the instruction occupied by the bit mask, was unable to specify any offset. Accordingly, in contrast to the earlier LDMIA instruction, it is not necessary for the base address used to directly identify the address required for the first transfer in the sequence. Since the base address is typically provided by the contents of one of the registers, this reduces the likelihood of needing to update the contents of that register prior to being able to perform the multiple transfer. Further, in contrast to the earlier described LDRD instruction, there is no requirement for the address to be 8-byte aligned. Indeed, in one embodiment of the present invention, the address determined from the new single transfer instruction can be any multiple of the data value size, and accordingly if the data value size is 32-bits, the address can be any multiple of 4 bytes.

In one embodiment, the base address is specified within the single transfer instruction by a base address register identifier identifying one of said plurality of registers that is arranged to store the base address. Typically there is insufficient space within the instruction itself to directly specify the base address, and hence this approach reduces the amount of space required within the instruction in order to specify a base address.

In one embodiment, the offset value is specified within the single transfer instruction by an offset register identifier identifying one of said plurality of registers that is arranged to store the offset value. However, since the offset value is typically a much smaller value than the base address, then it is often found that there is sufficient space within the instruction itself to specify the offset directly, and accordingly in an alternative embodiment, the offset value is specified by an immediate value provided within the single transfer instruction. By providing the offset value as an immediate value, thereby avoiding the need for a register lookup in order to determine the offset value, this can improve the performance of execution of the instruction. In addition, the codesize is smaller as an extra instruction is not required to load the offset value into a register.

It will be appreciated that the number of multiple data value transfers that may be performed by the single transfer instruction will be dependent on the space available within that instruction to specify register identifiers for each transfer. In one embodiment, the data processing unit is responsive to the single transfer instruction to perform two data value transfers. In one particular example, the single transfer instruction is a 32-bit instruction, and in such situations it has been found that sufficient space is available to allow two register identifiers to be specified, and accordingly for two transfers to be defined within the single transfer instruction. However, it will be appreciated that as number of bits available to specify the instruction increases, this will tend to increase the number of register identifiers that may be identified within the instruction, and hence will enable the single transfer instruction to define a larger number of multiple data value transfers. Alternatively, or in addition, more bits will allow a larger offset value to be specified.

It will be appreciated that the data values may be of any predetermined size. Typically, each data value may be the same size as each of the registers in the register file and hence as an example if each of the registers are 32-bits in length, then the data values might typically be 32-bit data values. However, it will be appreciated that the data values could in fact be smaller than the size of the registers if desired. In one embodiment, each of the data values comprise a 32-bit data word, and said consecutive data value addresses identify addresses for a series of adjacent 32-bit data words in the memory.

Whilst the use of the single transfer instruction will directly provide in software a reduction in code size, an increase in the performance of execution of the required transfer operations can also occur when the software is executed on the hardware, assuming the hardware supports the transfer of multiple data values in parallel. Accordingly, in one embodiment, the data processing apparatus further comprises an interface between said register file and said memory which facilitates the performance of said multiple data value transfers in parallel.

It will be appreciated by those skilled in the art that the “interface” will typically be significantly more complex than just a single connection path between the register file and memory, due to the presence of other logic units within the data processing apparatus, and the fact that the memory will typically be a multi-level memory system with one or more cache layers, Random Access Memory (RAM) layers, etc. However, provided that two or more data values can be transferred in parallel between the register file and the memory via the various interconnecting paths between the register file and memory, then this will allow significant performance benefits to be achieved. For example, with a hardware arrangement that has two write ports and two read ports provided for the register file, this will potentially allow two data values to be loaded into the register file, or two data values to be stored out of the register file to memory, within the same number of clock cycles that might otherwise be required just to perform a single load or store of a data value. Typically, this will take one cycle if a cache is used as the memory.

Viewed from a second aspect, the present invention provides a method of operating a data processing apparatus to transfer data values between a register file and a memory, the register file having a plurality of registers operable to store said data values for access by a data processing unit operable to perform data processing operations on said data values, the method comprising the steps of: in response to a single transfer instruction, performing multiple data value transfers between a corresponding multiple of said registers of said register file and consecutive data value addresses in a memory by: deriving said consecutive data value addresses from an address identifier provided by the single transfer instruction; determining for each of said data value transfers, with reference to a corresponding register identifier provided by said single transfer instruction, the register within said plurality of registers which is the subject of that data value transfer, the register identifier for each of said data value transfers being specifiable independently of the register identifiers specified for the other of said data value transfers; and performing the multiple data value transfers.

It will be appreciated that certain parts of the processing defined by each of the steps of the above method may be performed in parallel, and hence for example it is not necessary for all of the consecutive data value addresses to be derived before the registers the subject of each data value transfer are determined, and before any of the data value transfers are performed. Instead, as an example, a first data value transfer may be underway whilst the data value address and register for the next transfer are being determined.

Viewed from a third aspect, the present invention provides a computer program product having a computer program executable on a data processing apparatus having a data processing unit operable to perform data processing operations on data values and a register file having a plurality of registers operable to store said data values for access by the data processing unit, the computer program including a single transfer instruction which when executed on the data processing apparatus is operable to cause multiple data value transfers between a corresponding multiple of said registers of said register file and consecutive data value addresses in a memory by: deriving said consecutive data value addresses from an address identifier provided by the single transfer instruction; determining for each of said data value transfers, with reference to a corresponding register identifier provided by said single transfer instruction, the register within said plurality of registers which is the subject of that data value transfer, the register identifier for each of said data value transfers being specifiable independently of the register identifiers specified for the other of said data value transfers; and performing the multiple data value transfers.

### BRIEF DESCRIPTION OF THE DRAWINGS

The present invention will be described further, by way of example only, with reference to a preferred embodiment thereof as illustrated in the accompanying drawings, in which:

FIG. 1 is a block diagram schematically illustrating the relevant components of a data processing apparatus used in one embodiment of the present invention;

FIG. 2 is a block diagram illustrating the flow of signals between components of the data processing apparatus in accordance with one embodiment of the present invention;

FIG. 3 is a block diagram schematically illustrating the flow of signals between components of the data processing apparatus in accordance with a further embodiment of the present invention;

FIG. 4 is a flow diagram illustrating the execution of the load instruction of one embodiment of the present invention on the apparatus of FIG. 2;

FIG. 5 is a flow diagram illustrating the execution of the load instruction of one embodiment of the present invention on the apparatus of FIG. 3;

FIG. 6 is a flow diagram illustrating the execution of the store instruction of one embodiment of the present invention on the apparatus of FIG. 2;

FIG. 7 is a flow diagram illustrating the execution of the store instruction of one embodiment of the present invention on the apparatus of FIG. 3;

FIGS. 8A to 8E illustrate example sequences of two standard load instructions, and indicate whether those load instructions can be replaced by a single load instruction of an embodiment of the present invention, and whether they can be replaced by a known prior art single load instruction; and

FIG. 9 is a diagram schematically illustrating the encoding of the single load or store instruction of one embodiment of the present invention.

### DESCRIPTION OF PREFERRED EMBODIMENT

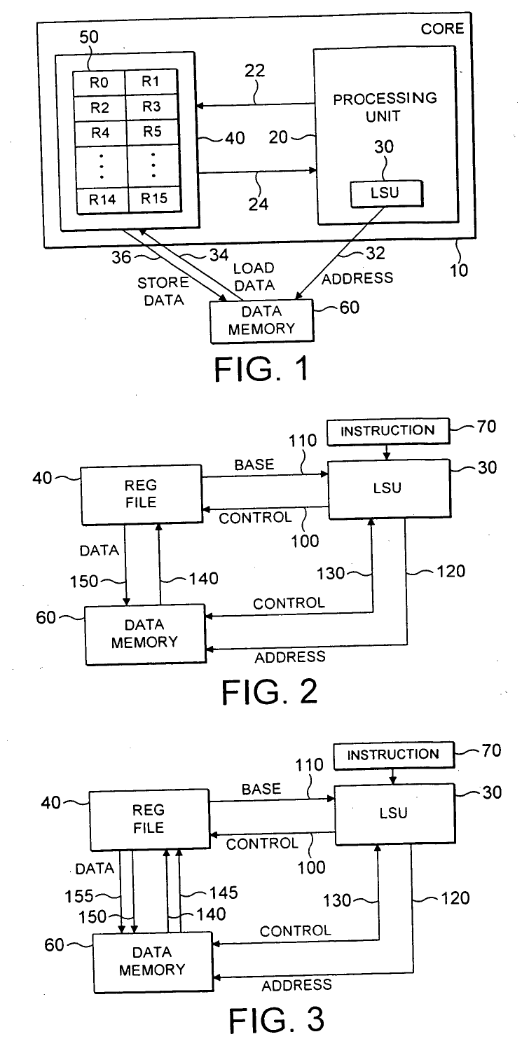

FIG. 1 is a schematic block diagram of a data processing apparatus in accordance with the present invention. In this example, the data processing apparatus takes the form of a processor core 10 within which is provided a data processing unit 20 and a register file 40. The register file contains a plurality of registers 50 and various other logic required to access those registers, such as write and read ports. As will be appreciated by those skilled in the art, the data processing until will typically include a number of functional logic units within it, for example an arithmetic logic unit (ALU), a floating-point unit (FPU), a load-store unit (LSU) 30, etc. The LSU 30 is the part of the data processing unit 20 responsible for controlling the transfer of data values between the registers 50 of the register file 40 and a data memory 60, and accordingly it is the LSU 30 that will be arranged to execute the single transfer instructions of preferred embodiments of the present invention.

When the data processing unit 20 is executing instructions, it will typically retrieve data values from the registers 50 over path 24, and may also write data values back to the registers 50 over path 22. In one embodiment of the present invention, the registers are 32-bit registers, and the data values are 32-bit data values, also referred to herein as 32-bit data words.

When the LSU 30 executes the single transfer instruction it may retrieve certain data from the registers 50 over path 24, for example the base address, and will then typically output one, or more addresses over path 32 to the data memory 60 to identify memory addresses involved in the transfer operations. Various control signals will also typically be passed from the LSU 30 to the register file 40, as will be discussed in more detail later, to identify the registers that are the subject of the various transfer operations. In the event that the single transfer instruction is a load instruction, this will result in the transfer of data over path 34 from the data memory 60 to the relevant registers 50 of the register file 40, whereas if the single transfer instruction is a store instruction, this will result in the transfer of data from the relevant registers 50 of the register file 40 over path 36 to the data memory 60.

FIG. 2 is a block diagram illustrating the flow of signals between the various elements discussed in FIG. 1 in an example hardware implementation where there is a single write port and a single read port provided for the register file 40. The single load instruction of preferred embodiments of the present invention that is used to perform two load transfers may be represented as follows:

LDRD_{NEW} R_{X}, R_{Y}, [R_{Z}, # OFFSET]

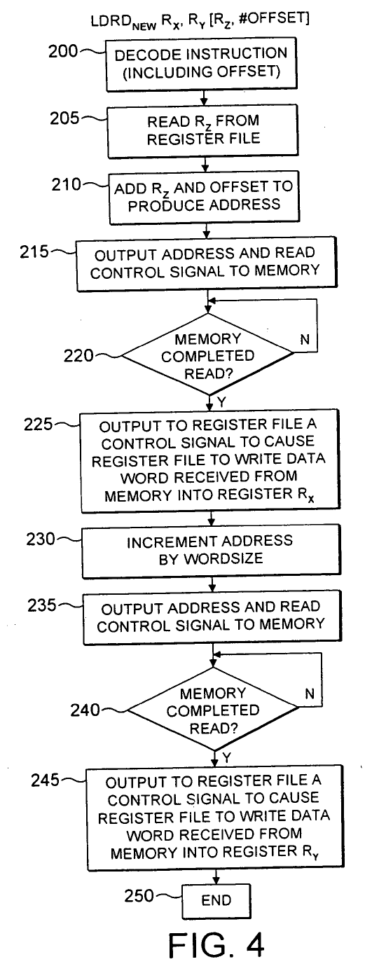

The execution of this instruction on the apparatus of FIG. 2 will now be described with reference to FIG. 4.

As shown in FIG. 2, the instruction 70 is passed to the LSU 30, where at step 200 it is decoded to identify the various register values R_{X}, R_{Y}, R_{Z}, and the offset value, which in this embodiment is provided as an immediate value within the LDRD_{NEW} instruction. Then, at step 205, a control signal is passed over path 100 to the register file 40 to cause the register R_{Z} to be read from the register file, resulting in the returning of the base address over path 110 to the LSU 30.

Thereafter, at step 210, the content of the register R_{Z}, i.e. the base address, is added to the offset value in order to produce an address for the first transfer. It will be appreciated that it is not essential for the combination of the base address and offset to identify the address for the first transfer since once one of the addresses is known, the other address can be identified by merely incrementing or decrementing the word size from the address. However, it is considered more efficient to arrange the base address and offset such that it identifies the address for the first transfer.

Once the address has been calculated at step 210, the process proceeds to step 215, where the address is output over path 120 to the data memory 60, and a control signal is also output to the memory 60 over path 130 to identify to the memory that the memory is required to read the data value from the address provided.

The memory may take a number of cycles to complete the read process whereafter (assuming a valid data value exists at that memory location) that data value will be asserted over the path 140 to the register file 40. Hence, at step 220, it is determined whether the memory has completed the read process, and when it has the process proceeds to step 225 where the LSU 30 is arranged to output to the register file a control signal over path 100 to cause the register file to write the data word received from the memory over path 140 into the register R_{X}. Whilst the path 140, and indeed the corresponding write path 150, is shown as a single interconnecting line between the data memory 60 and the register file 40, it will be appreciated by those skilled in the art that the interconnection between the data memory 60 and the register file 40 will typically be more complex than just a single connection path, due to the presence of other logic units within the data processing apparatus, and the fact that the memory will typically be a multi-level memory system. The single path 140 in FIG. 2 is merely intended to illustrate that only a single data value can be transferred from the data memory 60 to the register file 40 in a particular clock cycle, and similarly, the single write path 150 in FIG. 2 is intended to illustrate that a single data value can be written from the register file 40 to the data memory 60 in a particular clock cycle.

Once the received data value has been written into the register R_{X}, then the process proceeds to step 230, where the address is incremented by the word size in order to produce a consecutive data value address, i.e. a data value address adjacent to that used for the first transfer. As mentioned earlier, it is not essential for the instruction to be encoded such that the address is incremented at this stage, and in an alternative embodiment it could instead be arranged that the address is decremented by the word size at step 230 to identify the next address.

Once the new address has been determined by the LSU 30 at step 230, that address is then output at step 235 over path 120 to the data memory 60 along with a read control signal passed over path 130, thereby causing the data memory to read the data value from the identified memory location. Once it is then determined at step 240 that the memory has completed the read process, the LSU 30 is then arranged at step 245 to output to the register file over path 100 a control signal to cause the register file to write the data word received from the memory over path 140 into the register R_{Y}, whereafter the process ends at step 250.

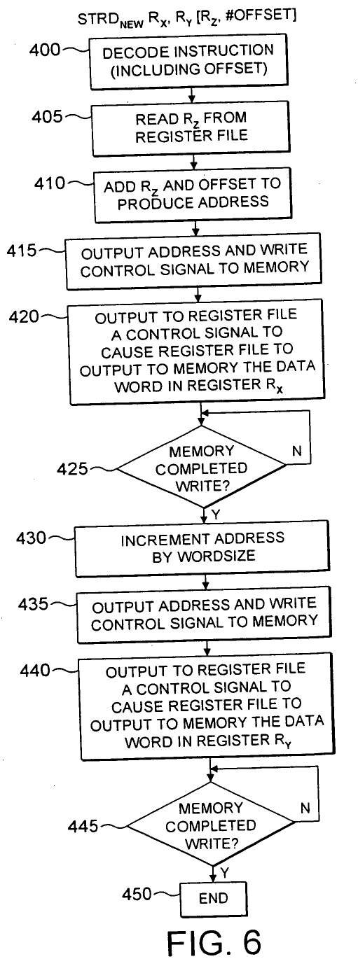

As will now be discussed with reference to FIG. 6, a similar process can be performed for the single store instruction of preferred embodiments of the present invention, which may be represented as follows:

STRD_{NEW} R_{X}, R_{Y}, [R_{Z}, # OFFSET]

As can be seen from a comparison of FIG. 6 with FIG. 4, steps 400 to 410 of FIG. 6 correspond to steps 200 to 210 of FIG. 4. At step 415, the address is output over path 120 to the data memory 60, and a write control signal is also output over path 130. In addition, at step 420, the LSU 30 is arranged to output to the register file 40 a control signal to cause the register file to output to memory over path 150 the data word in register R_{X}. It will be appreciated that steps 415 and 420 can be performed in parallel. At step 425, it is determined whether the memory has completed the write process (i.e. has written the data value received from the register file 40 into the memory location identified by the LSU 30), this typically being indicated by a signal returned from the memory 60 to the LSU 30 over the control path 130. When the memory has completed the write process, the process proceeds to step 430 where the LSU 30 is arranged to increment the address by the word size. Thereafter, at step 435, the address is output over path 120 along with a corresponding write control signal over path 130. In addition, at step 440, the LSU 30 outputs to the register file 40 a control signal over path 100 to cause the register file to output to the memory over path 150 the data word in register R_{Y}. Thereafter, it is determined at step 445 whether the memory has completed the write process, after which the process ends at step 450.

It will be appreciated from the above discussion of FIGS. 4 and 6 that whilst the use of the LDRD_{NEW} and STRD_{NEW} instruction yields benefits in its reduction of the code size that might otherwise be required, since as discussed earlier it is able to be used more frequently than either of the earlier-described prior art techniques for seeking to perform multiple transfers via a single transfer instruction, it is unlikely to produce a significant performance benefit when implemented on an apparatus as shown in FIG. 2, since the apparatus of FIG. 2 does not support multiple transfers between the register file 40 and memory 60 in parallel. The LSU 30 is likely to be arranged in a pipelined manner, so the two load or store operations will typically occur over two cycles, a single data transfer typically taking one cycle when occurring between the register file and a cache.

However, significant performance benefits can additionally be achieved if the apparatus of FIG. 3 is used. As is apparent from a comparison of FIG. 3 with FIG. 2, the apparatus is basically the same, except that two read paths 140, 145 are provided and two write paths 150, 155 are provided. Hence, in the FIG. 3 example, the register file 40 is provided with two read ports and two write ports, thus allowing the loading of two data values into two registers to occur in parallel, and also allowing the data values within two registers of the register file 40 to be output to memory in parallel.

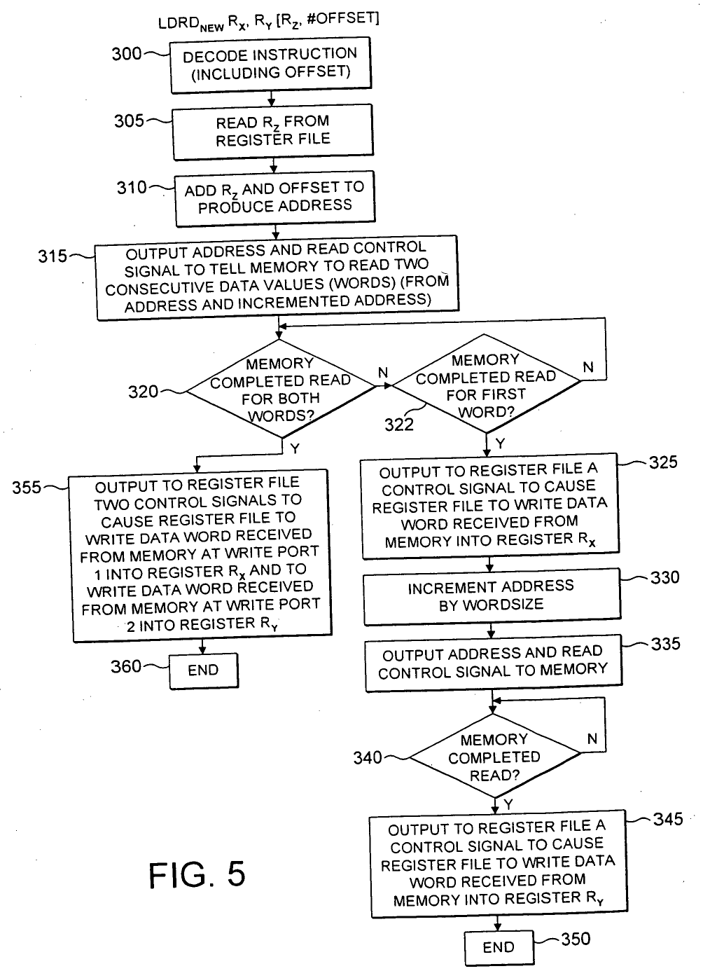

FIG. 5 is a flow diagram illustrating the processing performed by the LSU 30 when executing the LDRD_{NEW} instruction on the apparatus of FIG. 3. By comparison of FIG. 5 with FIG. 4, it can be seen that steps 300 to 310 of FIG. 5 correspond to steps 200 to 210 of FIG. 4. However, after step 310, the process now proceeds to step 315, where the address is output to the data memory 60 over path 120, and in addition a read control signal is passed over path 130 to instruct the memory to read two consecutive data values, also referred to herein as data words. In preferred embodiments, it is then implicit to the memory that it should read the first data word from the address provided and the second data word from an incremented version of the address.

The process then proceeds to step 320, where it is determined whether the memory has completed the read for both words. This will be indicated by a control signal returned over path 130 from the data memory 60 to LSU 30. If it has completed the read for both words, then the process proceeds to step 355, where the LSU 30 outputs to the register file over path 100 two control signals to cause the register file to write the data word received from memory at a first write port into register R_{X}, and also to write the data word received from memory at a second write port into the register R_{Y}. Thereafter the process ends at step 360. By this approach, a significant performance benefit can be realised, since two load operations will have been performed in the time otherwise required for a single load operation.

However, it is possible that the memory may not always be able to read two words within a particular clock cycle, for example because it may only be able to read two words in a clock cycle if the address is 8-byte aligned, or alternatively may just not have time to read both data words within that particular clock cycle. Accordingly, it is necessary to provide for the case where both words have not been read.

Thus, if at step 320 it is determined that the memory has not completed the read for both words, it is determined at step 322 whether the memory has completed the read for the first data word. This will again be indicated by a control signal returned from the data memory 60 to the LSU 30 over path 130.

If at step 322 it is determined that the memory has completed the read for the first word, the process proceeds to step 325, where the LSU 30 outputs a control signal over path 100 to the register file 40 to cause the register file to write the data word received from memory into register R_{X}. Thereafter, steps 330 through 350 are analogous to steps 230 through 250 of FIG. 4, and result in the second data word being loaded into the register R_{Y}.

As can be seen from a comparison of FIG. 4 with FIG. 5, when the LDRD_{NEW} instruction is executed on the apparatus of FIG. 3, then the performance can be increased in any instances where the memory is able to complete the read for both words within the same clock cycle, thereby enabling both words to be loaded into the register file in parallel at step 355 (i.e. a reduction from two cycles to one cycle). In addition, through the provision of steps 322 through 345, situations where the memory is unable to complete the read for both words within the same clock cycle can also be catered for.

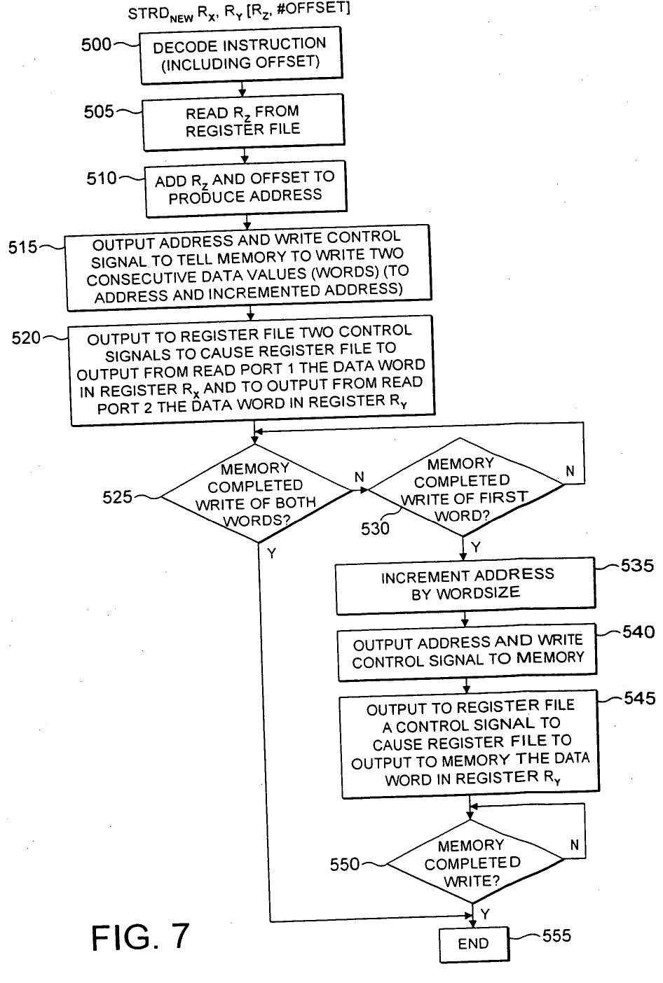

FIG. 7 is an analogous flow diagram to FIG. 6, but for the situation where the STRD_{NEW} instruction is executed on the apparatus of FIG. 3. Steps 500-510 of FIG. 7 are analogous to steps 400-410 of FIG. 6. However, at step 515, an address is output by the LSU 30 to the memory 60 along with a control signal instructing the memory to write two consecutive data words, the first data word being written into the specified address, and the second data word being written to an incremented version of the address determined by adding the data word size to the first address.

In addition, at step 520, the LSU 30 is arranged to output to the register file 40 over path 100 two control signals to cause the register file to output from a first read port the data word in register R_{X} and to output from a second read port the data word in register R_{Y}, resulting in two data words being output over paths 150, 155, respectively, to the data memory 60. It will be appreciated that steps 515 and 520 can be performed in parallel.

At step 525, it is determined whether the memory has completed the write of both words, this being indicated by a control signal returned over path 130 to the LSU 30. If it has, then the process proceeds directly to step 555, where the process ends. Otherwise, at step 530 it is determined whether the memory has completed the write of the first word, and if not the process returns to step 525.

However, if it is determined at step 530 that the memory has completed the write of the first word but not the second word, then the process proceeds to step 535 where the LSU is arranged to increment the address by the word size. Thereafter, steps 540 through 555 are analogous to steps 435 through 450 of FIG. 6, and result in the second data word being written to memory.

As can be seen from a comparison of FIG. 7 with FIG. 6, when the STRD_{NEW} instruction is executed on an apparatus such as that of FIG. 3, significant performance benefits (i.e. typically a reduction from two cycles to one cycle where a cache is used as the memory) can be realised in situations where the memory is able to complete the write of both words during the same clock cycle.

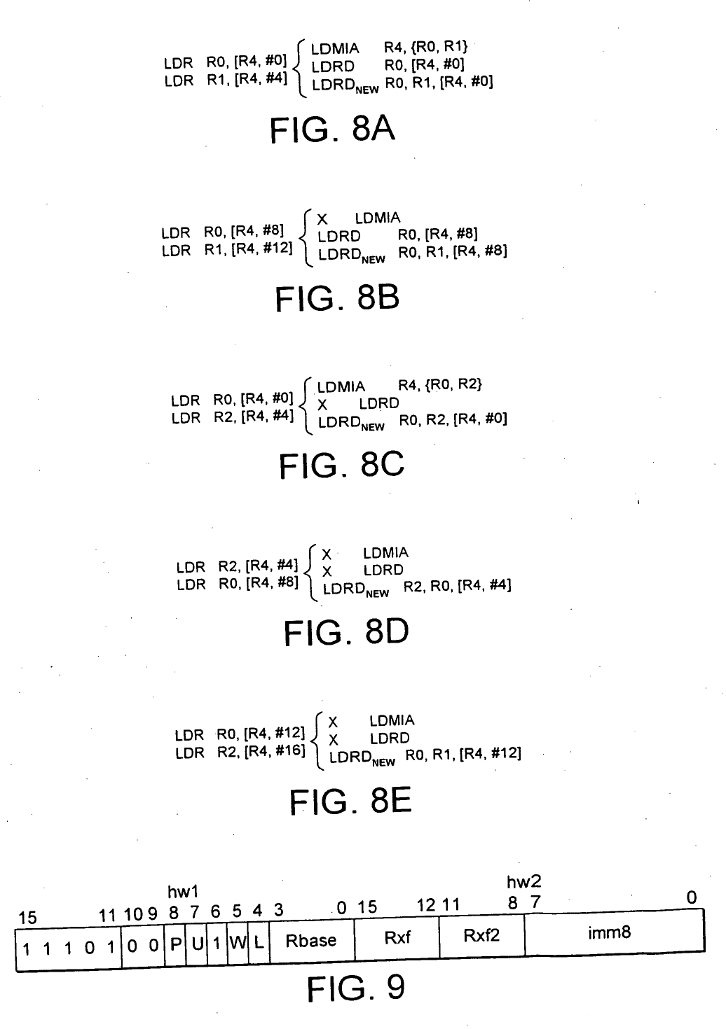

FIGS. 8A to 8E illustrate examples of two separate load instructions, each causing the transfer of a single data word, which may be candidates for replacing by a single load instruction, and in particular illustrate the additional flexibility afforded by the LDRD_{NEW} instruction of preferred embodiments over the earlier described known LDMIA and LDRD instructions.

As can be seen from FIG. 8A, the two LDR instructions illustrated in FIG. 8A can be replaced by either a single LDMIA instruction, a single LDRD instruction, or by a single LDRD_{NEW} instruction in accordance with preferred embodiments of the present invention. With regards to the LDMIA instruction, this is only possible because the register numbers are increasing for the two load operations, and the original offset is zero. For the LDRD instruction, this is only possible because the two load instructions are to an even-odd pair of registers.

As can be seen from FIG. 8B, this sequence of two LDR instructions cannot be represented by an LDMIA instruction, since the original offset is non-zero, and the LDMIA instruction is not able to specify a non-zero offset. However, the LDRD instruction can still be used since again the two LDR instructions are to an even-odd pair of registers. Additionally, the LDRD_{NEW} instruction can be used.

As shown in FIG. 8C, the LDMIA instruction can be used since the registers are increasing for each transfer, and the original offset is zero. However, the LDRD instruction cannot be used since the transfers are not to an even-odd pair of registers. However, the LDRD_{NEW} instruction can still be used since it is not subject to the constraints imposed on the LDRD instruction.

As shown in FIG. 8D, this particular pair of LDR instructions cannot be represented by an LDMIA instruction since the registers are not increasing between the loads, and in addition the original offset is not zero. Further an LDRD instruction cannot be used because the registers do not relate to an even-odd register pair. However, the LDRD_{NEW} instruction can still be used, since it is not subject to the constraints imposed upon the LDMIA or the LDRD instruction.

Again, as shown in FIG. 8E, only the LDRD_{NEW} instruction can represent this particular sequence of two LDR instructions. The LDMIA instruction cannot be used because the original offset is not zero, and in addition the LDRD instruction cannot be used because the address given by adding the base address to the offset will not be 8-byte aligned as required by the LDRD instruction. However, the LDRD_{NEW} instruction can be used because in preferred embodiments this instruction only requires that the address is a multiple of 4 bytes.

Accordingly, it can be seen from FIGS. 8A to 8E that the LDRD_{NEW} instruction of preferred embodiments of the present invention is far more flexible than the known prior art multiple transfer instructions and hence enables the code density and performance benefits to be realised more frequently within any particular given piece of code. It will be appreciated that a similar set of examples could be provided for store instructions to illustrate that the STRD_{NEW} instruction is more flexible than the known STMIA or STRD instructions.

As mentioned earlier, in one embodiment of the present invention, the LDRD_{NEW} and STRD_{NEW} instructions restrict the offset value to be 8 bits in length. Given that in one embodiment the address is also required to be a multiple of 4 bytes, this means that the offset value is multiplied by 4, and hence in effect provides a 10-bit offset.

FIG. 9 illustrates the encoding format of the LDRD_{NEW} and STRD_{NEW} instructions in one particular embodiment, where these instructions are 32-bit instructions. The first 5 bits on the left (11-15) are the major decode bits, a further 3 bits (bits 10, 9 and 6 in half word 1) specify that the instruction is an LDRD/STRD, and the PUWL bits say whether to start with the base address or with the base address plus the offset (P), whether the offset is added to or subtracted from the base address (U), whether it is a load or store (L) and whether the modified address is written back into the original register (W). As can be seen, the remaining 20 bits are used to specify the register containing the base address (Rbase), the offset value (imm8), and the two registers involved in the transfer (Rxf and Rxf2).

From the above description, it will be seen that the LDRD_{NEW} and STRD_{NEW} instructions of embodiments of the present invention provide significant benefits over the known multiple transfer instructions for loading or storing data. Due to the significantly increased flexibility of these new instructions, they can be used more frequently than would typically be possible with the known prior art techniques, thus enabling the increases in code density and performance to be more significant than would otherwise be possible with the known prior art instructions.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A data processing apparatus, comprising:
a data processing unit operable to perform data processing operations on data values;
a register file having a plurality of registers operable to store said data values for access by the data processing unit;
the data processing unit being responsive to a single transfer instruction to perform multiple data value transfers between a corresponding multiple of said registers of said register file and consecutive data value addresses in a memory, the single transfer instruction providing an address identifier from which said consecutive data value addresses are derivable, and further providing for each of said data value transfers a register identifier identifying the register within said plurality of registers which is the subject of that data value transfer, said register identifier for each of said data value transfers being specifiable independently of the register identifiers specified for the other of said data value transfers.

2. A data processing apparatus as claimed in claim 1, wherein said single transfer instruction is a load instruction, the data processing unit being responsive to the load instruction to perform said multiple data value transfers from the consecutive data value addresses in said memory to said corresponding multiple of said registers of said register file.

3. A data processing apparatus as claimed in claim 1, wherein said single transfer instruction is a store instruction, the data processing unit being responsive to the store instruction to perform said multiple data value transfers from said corresponding multiple of said registers of said register file to the consecutive data value addresses in said memory.

4. A data processing apparatus as claimed in claim 1, wherein the address identifier comprises a base address and an offset value.

5. A data processing apparatus as claimed in claim 4, wherein the base address is specified within the single transfer instruction by a base address register identifier identifying one of said plurality of registers that is arranged to store the base address.

6. A data processing apparatus as claimed in claim 4, wherein the offset value is specified within the single transfer instruction by an offset register identifier identifying one of said plurality of registers that is arranged to store the offset value.

7. A data processing apparatus as claimed in claim 4, wherein the offset value is specified by an immediate value provided within the single transfer instruction.

8. A data processing apparatus as claimed in claim 1, wherein the data processing unit is responsive to the single transfer instruction to perform two data value transfers.

9. A data processing apparatus as claimed in claim 1, wherein each of said data values comprise a 32-bit data word, and said consecutive data value addresses identify addresses for a series of adjacent 32-bit data words in the memory.

10. A data processing apparatus as claimed in claim 1, further comprising an interface between said register file and said memory which facilitates the performance of said multiple data value transfers in parallel.

11. A method of operating a data processing apparatus to transfer data values between a register file and a memory, the register file having a plurality of registers operable to store said data values for access by a data processing unit operable to perform data processing operations on said data values, the method comprising the steps of:
in response to a single transfer instruction, performing multiple data value transfers between a corresponding multiple of said registers of said register file and consecutive data value addresses in a memory by:
deriving said consecutive data value addresses from an address identifier provided by the single transfer instruction;
determining for each of said data value transfers, with reference to a corresponding register identifier provided by said single transfer instruction, the register within said plurality of registers which is the subject of that data value transfer, the register identifier for each of said data value transfers being specifiable independently of the register identifiers specified for the other of said data value transfers; and
performing the multiple data value transfers.

12. A method as claimed in claim 11, wherein said single transfer instruction is a load instruction, in response to the load instruction, the method performing said multiple data value transfers from the consecutive data value addresses in said memory to said corresponding multiple of said registers of said register file.

13. A method as claimed in claim 11, wherein said single transfer instruction is a store instruction, in response to the store instruction the method performing said multiple data value transfers from said corresponding multiple of said registers of said register file to the consecutive data value addresses in said memory.

14. A method as claimed in claim 11, wherein the address identifier comprises a base address and an offset value.

15. A method as claimed in claim 14, wherein the base address is specified within the single transfer instruction by a base address register identifier identifying one of said plurality of registers that is arranged to store the base address.

16. A method as claimed in claim 14, wherein the offset value is specified within the single transfer instruction by an offset register identifier identifying one of said plurality of registers that is arranged to store the offset value.

17. A method as claimed in claim 14, wherein the offset value is specified by an immediate value provided within the single transfer instruction.

18. A method as claimed in claim 11, wherein in response to the single transfer instruction, the method performs two data value transfers.

19. A method as claimed in any claim 11, wherein each of said data values comprise a 32-bit data word, and said consecutive data value addresses identify addresses for a series of adjacent 32-bit data words in the memory.

20. A method as claimed in claim 11, wherein said multiple data value transfers between said register file and said memory are performed in parallel.

21. A computer program product having a computer program executable on a data processing apparatus having a data processing unit operable to perform data processing operations on data values and a register file having a plurality of registers operable to store said data values for access by the data processing unit, the computer program including a single transfer instruction which when executed on the data processing apparatus is operable to cause multiple data value transfers between a corresponding multiple of said registers of said register file and consecutive data value addresses in a memory by:
deriving said consecutive data value addresses from an address identifier provided by the single transfer instruction;
determining for each of said data value transfers, with reference to a corresponding register identifier provided by said single transfer instruction, the register within said plurality of registers which is the subject of that data value transfer, the register identifier for each of said data value transfers being specifiable independently of the register identifiers specified for the other of said data value transfers; and
performing the multiple data value transfers.

22. A computer program product as claimed in claim 21, wherein said single transfer instruction is a load instruction which when executed on the data processing apparatus is operable to cause said multiple data value transfers to be performed from the consecutive data value addresses in said memory to said corresponding multiple of said registers of said register file.

23. A computer program product as claimed in claim 21, wherein said single transfer instruction is a store instruction which when executed on the data processing apparatus is operable to cause said multiple data value transfers to be performed from said corresponding multiple of said registers of said register file to the consecutive data value addresses in said memory.

24. A computer program product as claimed in claim 21, wherein the address identifier comprises a base address and an offset value.

25. A computer program product as claimed in claim 24, wherein the base address is specified within the single transfer instruction by a base address register identifier identifying one of said plurality of registers that is arranged to store the base address.

26. A computer program product as claimed in claim 24, wherein the offset value is specified within the single transfer instruction by an offset register identifier identifying one of said plurality of registers that is arranged to store the offset value.

27. A computer program product as claimed in claim 24, wherein the offset value is specified by an immediate value provided within the single transfer instruction.

28. A computer program product as claimed in claim 21, wherein when the single transfer instruction is executed on the data processing apparatus, two data value transfers are performed.

29. A computer program product as claimed in claim 21, wherein each of said data values comprise a 32-bit data word, and said consecutive data value addresses identify addresses for a series of adjacent 32-bit data words in the memory.

30. A computer program product as claimed in claim 21, wherein said multiple data value transfers between said register file and said memory are performed in parallel.

31. A computer program operable to configure a data processing apparatus to perform a method as claimed in claim 11.

32. A carrier medium comprising a computer program as claimed in claim 31.
